(19) United States
(12) Patent Application Publication
(10) Pub. No.: US 2011/0255927 A1
(43) Pub. Date: Oct. 20, 2011

(54) Drill saw and cutting tool

(75) Inventors: Michael Boudreau, Salmon Arm (CA); Carl Flatman, Salmon Arm (CA); David Marak, Salmon Arm (CA); Troy Karius, Salmon Arm (CA)

(73) Assignee: Technology Brewing Corporation

(21) Appl. No.: 12/662,423

(22) Filed: Apr. 16, 2010

(51) Int. Cl. B25F 3/00; B23D 57/00; B23B 45/00

(52) U.S. Cl. 408/22; 173/47; 279/144

(57) ABSTRACT

A drill saw includes a motor, a drive shaft rotationally driven by the motor for rotation of the drive shaft about a corresponding drive axis, a transmission cooperating with the drive shaft to convert the rotation of the drive shaft to a driven output. The transmission includes a shuttle member having first and second gears. The shuttle member is slidably mounted for translation between first and second positions. A rotary motion-to-linearly reciprocating, motion converter operatively cooperates with the first gear when the shuttle member is in the first position so that a first driven output drives an output shaft reciprocatingly and linearly along an output axis. A rotary motion-to-rotary motion coupler operatively cooperates with the second gear when the shuttle member is in the second position so that a second driven output drives the output shaft rotationally about the output axis.

### FIELD OF THE INVENTION

This invention relates to the design of a multi-functional power tool and its blade. The tool may be operated as either a rotary drill or a reciprocating saw. A compound bevel gear engages one of two gears to produce either of the two desired types of motion. The end user is able to toggle between rotary and reciprocating modes with a manual switch.

### BACKGROUND OF THE INVENTION

Over the course of a typical construction project including but not limited to framing, dry-walling, or custom woodworking it may be necessary to switch between an assortment of power tools, the primary ones being a drill and a saw. It is not always convenient or affordable to keep both of these tools on hand. To many it would be desirable to have a single tool capable of performing both of the required functions. It is thus an object of the present invention to provide a single tool capable of both sawing and drilling modes, and not requiring any attachments or disassembly in order to change between modes.

The applicant is aware of patents regarding reciprocating saw motion adapted from a rotary drill such as U.S. Pat. No. 6,264,211 titled “Reciprocating Saw Attachment for Electric Drill”, issued to Granado on Jul. 24, 2001. This describes an attachment that makes use of bevel gears with an eccentric peg and control arm that produces reciprocating motion from the rotation of the drill. The design includes a collar which permits manual tightening of the chuck. The internal components are typically hardened steel, while the case is a hard plastic. Objectives include the ability to attach to all models of drills, with quick connect and disconnect, and to be near maintenance free.

Applicant is also aware of U.S. Pat. No. 6,820,339 titled “Right Angle Accessory Saw for Use with Electric Drill”, which issued to Albrightson on Apr. 1, 2004, and which describes an accessory for an electric drill which produces reciprocating motion for a saw blade at a right angle to the axis of the drill. The motion is achieved through the use of a cam in the accessory which drives the forward motion of a push rod. The push rod is spring biased towards the cam to complete the cycle of motion. The present invention differs from this design by maintaining the same axis for both rotation and translation in a single compact unit.

The embodiment of the present invention ensures power is delivered through the entire cycle using a Scotch yoke mechanism to produce the reciprocating motion.

U.S. Pat. No. 5,766,293 titled “Drill/Saw Apparatus”, issued to Bourke on May 26, 1998, describes a compact drill attachment which converts rotary motion of the drill to reciprocating saw action. It does so using a set of bevel gears and an eccentric peg, which in turn drives a slotted arm to which &saw blade is attached. The patent seeks to cover a variety of speeds, stroke lengths, stroke speeds, and cutting angles in its design for a cordless drill attachment. A hex key fitting is described to enable easy insertion of a power drill into the apparatus at a variety of locations. Various mechanisms such as a worm gear, rack and pinion, and a counterbalancing flywheel are shown in differing adaptations of the original design.

U.S. Pat. No. 4,972,589 titled “Cutting and Sanding Attachments for a Hand Drill”, issued to Povleski on Nov. 27, 1990, describes an attachment that allows a rotary saw or drum sander to be attached to a cordless drill. The design does not produce reciprocating motion. It has a false trigger, which consists of a connecting rod that allows the trigger on the drill to be operated from a position closer to the saw blade. Changing between drilling, sawing, and sanding requires removal of the attachments. The patent also mentions the need to change gears in order to achieve the correct speeds, which does not appear ideal in terms of minimizing the lag time between mode changes.

The applicant is also aware of U.S. Pat. No. 6,641,467 titled “Power Tool”, issued to Robson and Wadge on Feb. 12, 2004: Applicant is also aware of U.S. Pat. Nos. 6,170,579 and 6,263,980 issued to Wadge. These describe a power tool with a rotary fitting onto which a plurality of adapting tool heads may be attached. These include a rotary drill, a jigsaw, as well as a sander. An attachment must be interchanged to switch from sawing to drilling.

Regarding a single power tool that can drive both a drill bit and an elongated saw blade, applicant is aware of:

U.S. Pat. No. 6,170,579 titled “Power Tool Having Interchangeable Tool Head” issued to Brian Wadge on Jan. 9, 2001 teaches a generic power tool having a motor driving a rotary output shaft. The power tool detachably engages one of a plurality of tool heads including a drill chuck, reciprocating saw, sander head and nibbler tool. The reciprocating saw attachment includes a complex mechanism for converting the rotary input motion to reciprocating linear output motion.

U.S. Pat. No. 6,782,781 titled “Saw Blade For Reciprocating Saw Apparatus” issued to Allan A. Rack on Aug. 31, 2004 discloses a saw blade having a toothed, rounded tip for use with a reciprocating saw. In order to start a cut, the user places the tip of the blade on the material to be cut and holds the reciprocating saw such that the blade forms approximately a 45-degree angle with the material. In this way, the tip of the saw blade cuts a groove into the material and eventually cuts through the material so that the blade can pass through and the primary cutting edge can come into contact with the sheet.

U.S. Pat. No. 2,529,157 titled “Routing Tool” issued to Robert J. Higerd on Nov. 7, 1950 teaches a power tool cutting attachment for use with a router. The router bit is rotated at high speeds and cuts sheet material with a plurality of cutting edges spaced evenly around its circumference.

### SUMMARY OF THE INVENTION

The present invention combines the two common power tool options of a rotary drill and a reciprocating saw into a single compact device. One can change between the two modes by flipping a switch on the side of the case. A compound bevel gear allows power to be transferred to either a spur gear to drive the drill, or to a larger bevel gear with an eccentric peg to drive a Scotch yoke mechanism for the reciprocating saw. The toggling mechanism contains a shaped slide pin which restricts the tool holder to either rotation in the drill mode or translation in the saw mode. A magnetic sensor is used to detect position of the shaft and stop it in the appropriate location to allow for accurate toggling between modes. The gears are mounted in a hard plastic casing which is fixed to a pistol grip style handle housing a motor and the triggering device. A toothed blade for the tool has a spade drill bit tip that can ream holes as well as cut slots. The blade comprises an elongate body similar to a conventional reciprocating saw blade having cutting teeth angled towards the power tool on its lower surface such that the blade will cut the material on its backward stroke. The blade is provided with power-tool engaging means at one end such that it can be driven in linearly as well as rotationally. At its other end, the cutting tool has the profile of a spade bit for a drill, such that the same tool can be used for drilling a pilot hole and cutting the sheet of material.

In summary the drill saw according to one aspect of the present invention may be characterized as including:

a) a motor,
b) a drive shaft rotationally driven by the motor for rotation of the drive shaft about a corresponding drive axis,
c) a transmission cooperating with the drive shaft to convert the rotation of the drive shaft to a driven output,
d) an output shaft lying on an output axis and cooperating with the transmission for imparting the driven output to the output axis,
wherein the transmission includes:

i) a housing,

ii) a shuttle member having first and second gears mounted thereon, wherein the shuttle member is slidably mounted to the housing for translation between first and second positions,

iii) a rotary motion-to-linearly reciprocating motion converter mounted in the housing and operatively cooperating with the first gear when the shuttle member is in the first position, and wherein when the shuttle member is in the first position the driven output is a first driven output driving the output shaft reciprocatingly and linearly along the output axis,

iv) a rotary motion-to-rotary motion coupler mounted in the housing and operatively cooperating with the second gear when the shuttle member is in the second position, and wherein when the shuttle member is in the second position the driven output is a second driven output driving the output shaft rotationally about the output axis,

e) an actuator for selectively actuating the shuttle member between the first and second positions.

In one embodiment the output shaft includes a groove extending linearly along an outer surface of the output shaft and parallel to output axis. A guide member is slidably mounted in the housing for sliding translation between an engaged position wherein the guide member engages in the groove as the output shaft is driven by the first driven output, and a disengaged position wherein the guide member is disengaged from the groove as the output shaft is driven by the second driven output.

The guide member may be actuated between the engaged and disengaged positions by an actuating linkage extending between the guide member and the actuator and cooperating with the actuator so as to actuate the guide member into the engaged position when the shuttle member is actuated into the first position and so as to actuate the guide member into the disengaged position when the shuttle member is actuated into the second position. For example, the actuating linkage may include a portion of the shuttle member, and in particular where the portion of the shuttle member is a protrusion of the shuttle member, the protrusion driving the guide member upon actuation.

The guide member may be resiliently biased into the groove by a resilient biasing means such as a spring. The guide member may further include a collar through which the output shaft is journalled so as to pass therethrough, in which embodiment the protrusion may then drive the collar so as to drive said guide member against the resilient biasing of the resilient biasing means.

In one embodiment the rotary motion-to-linearly reciprocating motion converter includes a driving wheel having a gear engaging surface which engages with the first gear on shuttle member when the shuttle member is in the first position, and a driving linkage eccentrically mounted at one end of the linkage to the wheel and mounted at its opposite end to the output shaft whereby rotation of the wheel drives the linkage to thereby linearly translate and reciprocate the output shaft along the output axis. For example, the wheel and the linkage may be collectively formed as a scotch yoke rotary-to-linear motion converter.

The rotary motion-to-rotary motion coupler may include a rotary output gear mounted on the output shaft cooperating with the second gear when the shuttle member is in the second position. Advantageously, the rotary output gear and the second gear are substantially parallel and, when the shuttle member is in the second position, are substantially co-planar.

In one preferred embodiment, the first gear is a first bevel gear and the gear engaging surface on the wheel is a second bevel gear, and the wheel is orthogonal to the first gear. For example, the first bevel gear and the second gear may form collectively a compound bevel gear where the first and second gears are parallel and adjacent.

In a further aspect of the present invention, a position sensor is mounted in the housing to sense an instantaneous rotary and linear position of the output shaft. A processor cooperates with the position sensor so that the processor may determine when the groove is aligned with the guide member when the shuttle member is in the first position, and so that the processor may determine when the rotary motion-to-rotary motion coupler are operatively connected when the shuttle member is in the second position.

In yet a further aspect, the drillsaw according to the present invention further includes a flat elongate blade having a chuck engaging end, an opposite distal end and a bottom edge extending therebetween along a lower edge of the blade. An array of cutting teeth are formed or mounted along the bottom edge. A drill bit, for example a spade drill bit is formed or mounted at the distal end. The chuck-engaging end is adapted for mounting the blade to the output shaft along the output axis.

### BRIEF DESCRIPTION OF THE DRAWINGS

FIG. 1 shows an isometric view of the complete drill saw assembly.

FIG. 2 shows the same view without the top cover or the handle containing the motor.

FIG. 3a shows a cross-sectional view of the drill saw assembly from the side in its drill mode.

FIG. 3b shows a cross-sectional view of the drill saw assembly from the side in its saw mode.

FIG. 4a shows a side profile of the internal mechanisms within the drill saw in its drill mode.

FIG. 4b shows a side profile of the internal mechanisms within the drill saw in its saw mode.

FIG. 5a shows a plan view of the view of FIG. 4a.

FIG. 5b shows a plan view of the view of FIG. 4b.

FIG. 6 shows an isometric view of FIG. 5a.

FIG. 7 is, in perspective view, one embodiment of a guide member, and in particular a slide pin.

FIG. 8 is a diagrammatic view of a sensor circuit for sensing the position of the tool holder.

FIG. 9 is an enlarged partially cut-away perspective view of the tip of the drill saw blade.

FIG. 10 is, in enlarged perspective view, one embodiment of the tool holder according to the present invention.

FIG. 11 is, in partially exploded perspective view, a drill saw according to a preferred embodiment of the present invention.

### DETAILED DESCRIPTION OF EMBODIMENTS OF THE INVENTION

The present invention includes a compact, cordless power tool, producing rotation or reciprocation of a cutting tool blade depending on the mode selected.

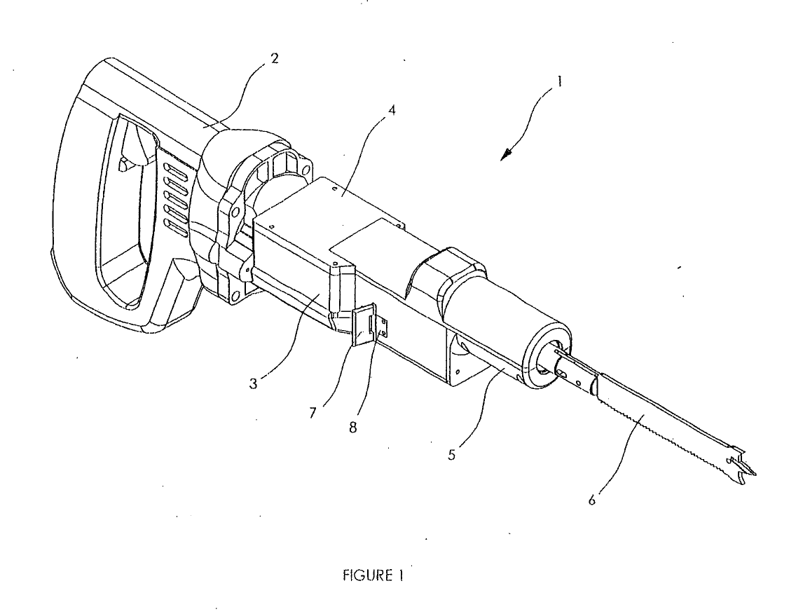

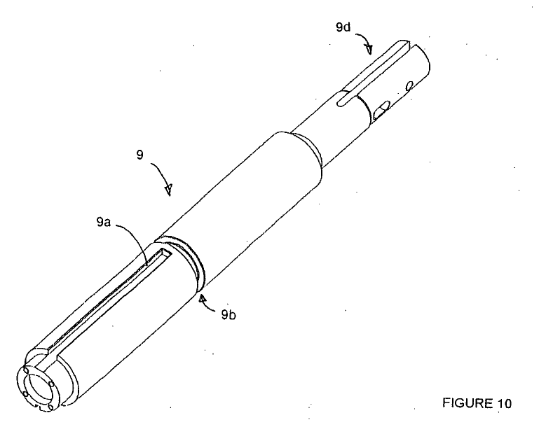

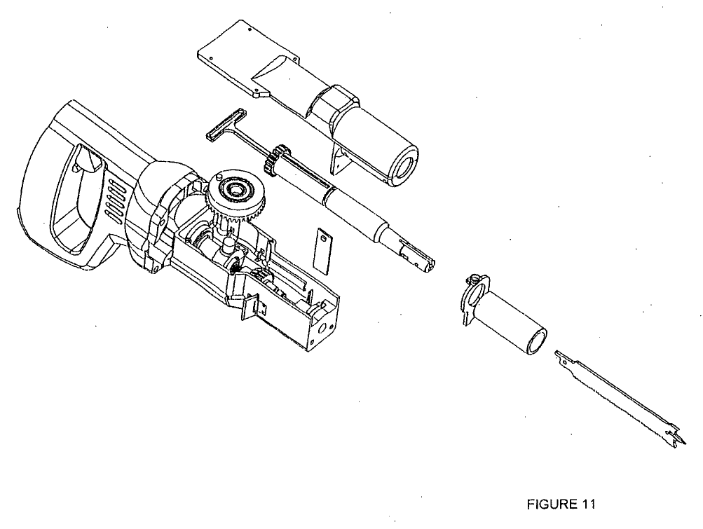

The following description is to be read in conjunction with a review of FIGS. 1-12 as described above wherein similar characters of reference denote corresponding parts in each view.

FIG. 1 shows an external view of the drill saw assembly 1. A typical power tool handle 2 contains a motor and trigger mechanism. The trigger governs the flow of current, and hence the power delivered to the motor. The shaft of this motor is coupled to the drill saw mechanism to provide motion to the cutting tool 6. The internal components for the drill saw assembly 1 are housed in sections of a hard plastic casing, namely the motor mount casing 3, top cover 4, and bottom cover 5. Attached to the side of the motor mount casing 3 is the toggle switch 7, affixed with a bracket 8.

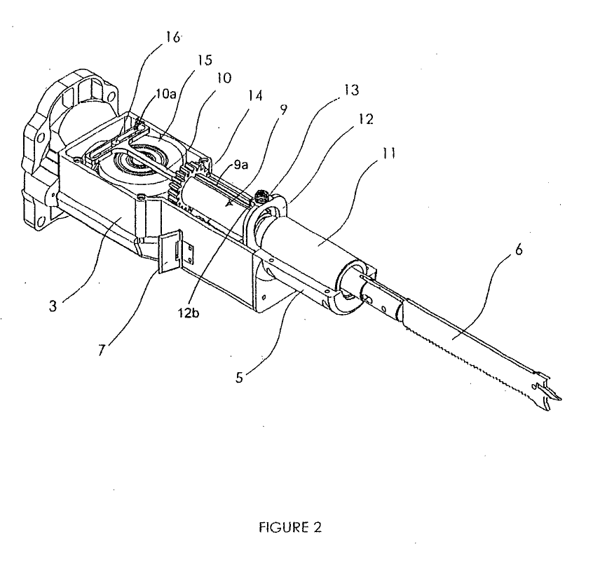

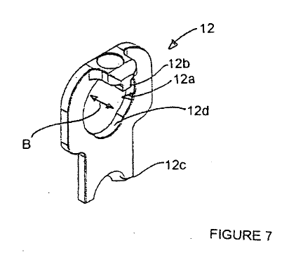

FIG. 2 shows the same view as FIG. 1 with the handle and top cover removed to reveal some of the internal components of the drill saw assembly. The tool holder 9 is able to either reciprocate or rotate. A guide member such as slide pin 12, as better seen in FIG. 7, moves up and down between raised and lowered positions, to either allow the tool holder 9 to pass for reciprocating motion, or to fix tool holder 9 in place so as to allow only rotary motion. The slide pin 12 is actuated from below. A spring 13 is used to resiliently maintain the position of slide pin 12. A spur gear 14 is fixed to the tool holder 9 to produce rotary motion when the rotary or drill mode is toggled. For reciprocating motion the tool holder 9 is driven by the Scotch yoke push rod 10, and supported by a linear-rotary bearing 11. The larger center bevel gear 15 produces the reciprocating motion, driving an eccentric pin 16 within a guide slot 10a of Scotch yoke push rod 10.

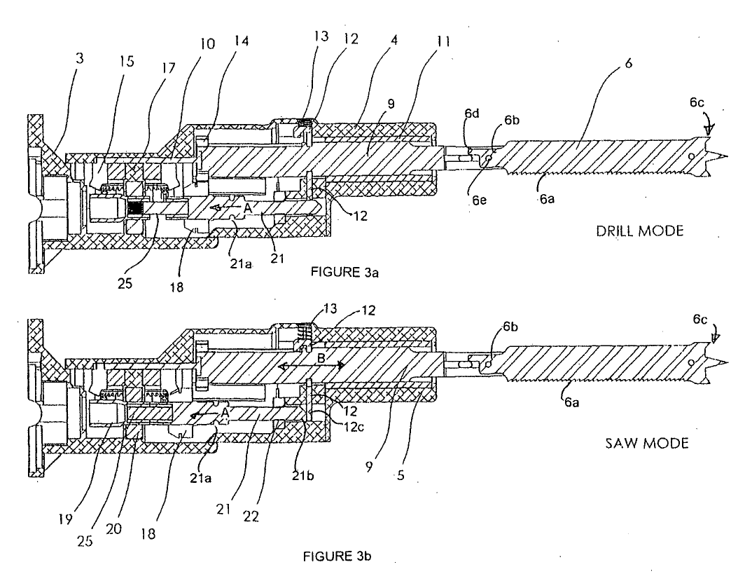

The inner workings are shown in cross section in FIGS. 3a and 3b. The mode toggle shaft 21 serves as a shuttle member which shuttles between two positions when actuated by the toggle switch 7. Pushing the switch 7 forward engages grooves 21a and drives the shaft 21 rearwards in direction A, placing the tool in the saw mode of FIG. 3b. The compound bevel gear 18 engages the center bevel gear 15, and the slide pin 12 is forced downwards by the spring 13. This permits the tool holder 9 to pass in direction B through aperture 12a in slide pin 12, and causes the tool holder to be driven back and forth in direction B by the Scotch yoke push rod 10. An arm 12b on slide pin 12 engages a slot 9a on tool holder 9 to prevent it from rotating. Pulling rearwardly on switch 7 drives mode toggle shaft 21 forward into its drill mode. As shaft 21 is driven forward, its tapered end 21b engages cam surface or strike surface 12c on slide pin 12, urging slide pin 12 upwards, so as to engage collar 12d in annular groove 9b and thereby inhibit tool holder 9 from translating in direction B. Compound bevel gear 18 is mounted on shaft. 21. Shaft 21 engages teeth 18a of compound bevel gear 18 with spur gear 14 on the tool holder 9. The slide pin 12 which now permits only rotation of the tool holder keeps the two gears in alignment. The center bevel gear 15 is supported by a bracket 17 which straddles the bearing 20 for the motor shaft adaptor 19. Adaptor 19 transfers the rotation about the drive shaft axis of rotation C of the motor drive shaft (not shown) through a splined shaft 25 to the mode toggle shaft 21. The splined shaft 25 mounts shaft 21 telescopically onto the motor drive shaft via adaptor 19 and thereby allows the shaft 21 to translate fore and aft when toggled by switch 7 without interfering with the rotation of shaft 21.

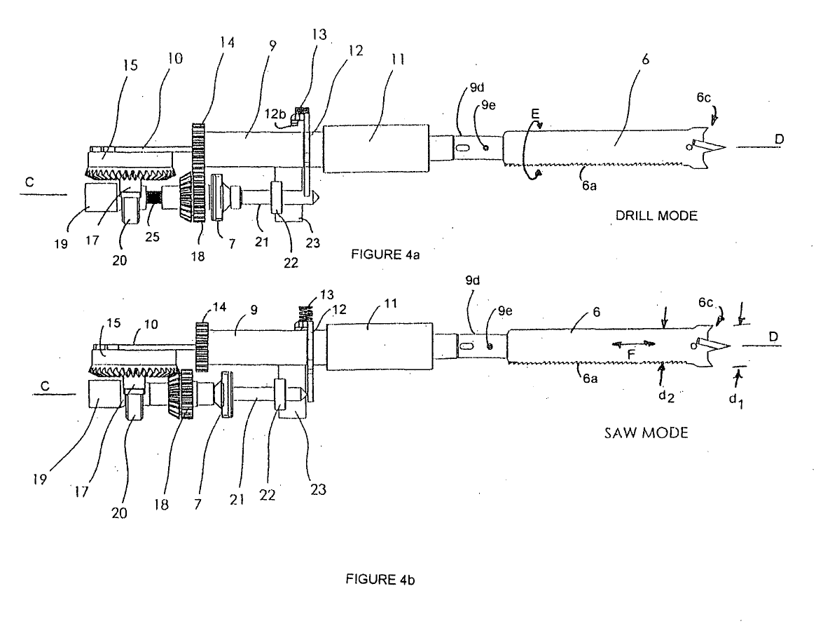

FIGS. 4a and 4b illustrates the internal components of the drill saw from a side view with the casing and covers removed. The toggle switch 7 shown pulled back in drill mode in FIG. 4a, causes the mode toggle shaft 21 to advance which elevates slide pin 12 and allows for rotary motion of tool holder 9. In saw mode as seen in FIG. 4b, the shaft 21 is slid rearwardly by the advancing of toggle switch 7, which allows slide pin 12 to lower under the resilient biasing of spring 13 thereby positioning slide pin 12 to allow the tool holder to reciprocate.

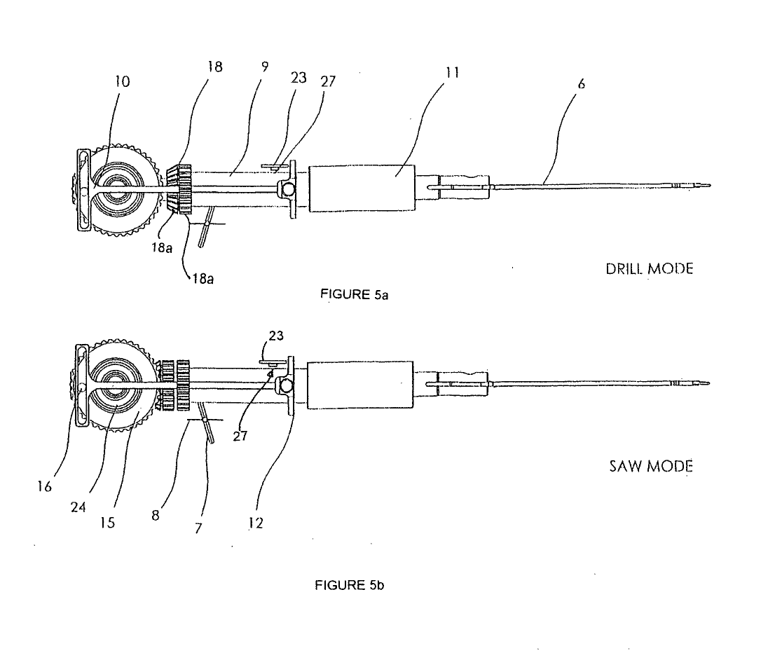

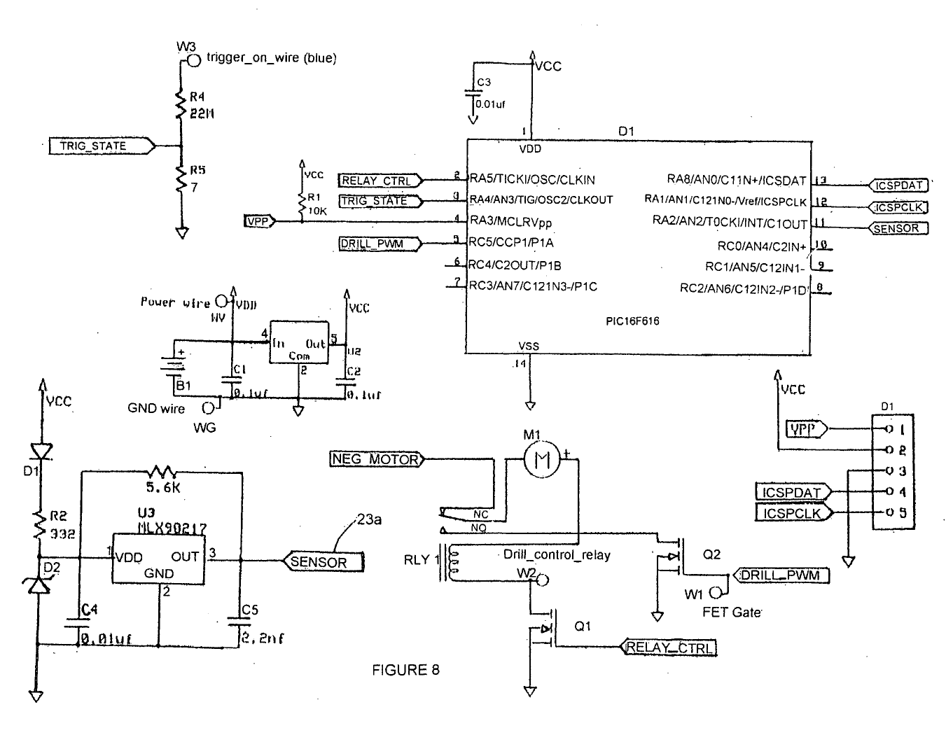

A circuit board 23 such as diagrammatically illustrated in FIG. 8 cooperates with a magnetic “hall effects” sensor 23a to detect the position of the shaft 21 in order to stop it in the correct position. The tool saw/drill bit 6 is mounted to tool holder 9 to align co planar with channel 9a. A small magnet 27, seen in FIGS. 5a and 5b, is embedded in tool holder 9. Magnet 27 is detected by sensor 23a on circuit board 23, which sends a signal to stop the tool holder 9 in the correct position when the trigger is released. When the tool is operated in the reciprocating mode, the same sensor 23a detects the magnetic field of the tool holder 9 as it translates past the circuit board. When the trigger is released the sensor 23a assists to position the tool holder 9 correctly to allow the slide pin 12 to engage the tool holder 9 to change between drilling/sawing modes.

Thus, as mentioned above, the drill saw according to the present invention operates in two modes: drill or saw mode. The ability to switch between the modes in one preferred embodiment advantageously uses mechanical alignment when the device is stopping. To accomplish this function circuit 23 takes control of the drill saw after the ON button is released. A small processor monitors the status of the trigger button. If the button is released the processor takes control of the drill saw motor and provides a slow constant velocity. When the drill saw approaches the alignment point magnet 27 embedded into tool holder 9 triggers a hall effects sensor 23a on the controller board 23. The processor stops the motor and returns control to the drill saw. The drill saw is thus aligned and slide pin 12 may be elevated or lowered between drill and saw mode.

A plan view of the internal components of the drill saw shown in FIGS. 5a and 5b provides another view of how the parts are aligned. The positional sensor 23a on the circuit board 23 aligns with a magnet 27 on the tool holder 9 in its home position as seen in FIGS. 5a and 5b, where slide pin 12 can be toggled between modes. The slide pin 12 translates vertically in a plane containing annular groove 9b on tool holder 9 when switching between modes. Arm 12b in channel 9a prevents tool holder 9 from rotating about its longitudinal axis (the output axis D of the drill saw) when in reciprocating mode.

The center bevel gear 15 which is pressed into a bearing 24, drives an eccentric pin 16 in a circular path. This is converted to linear motion by the Scotch yoke T-slot 10a on the end of push rod 10. The tool holder 9 is supported and able to both translate along and rotate about axis D within the linear-rotary bearing 11, which has a low-friction coated surface.

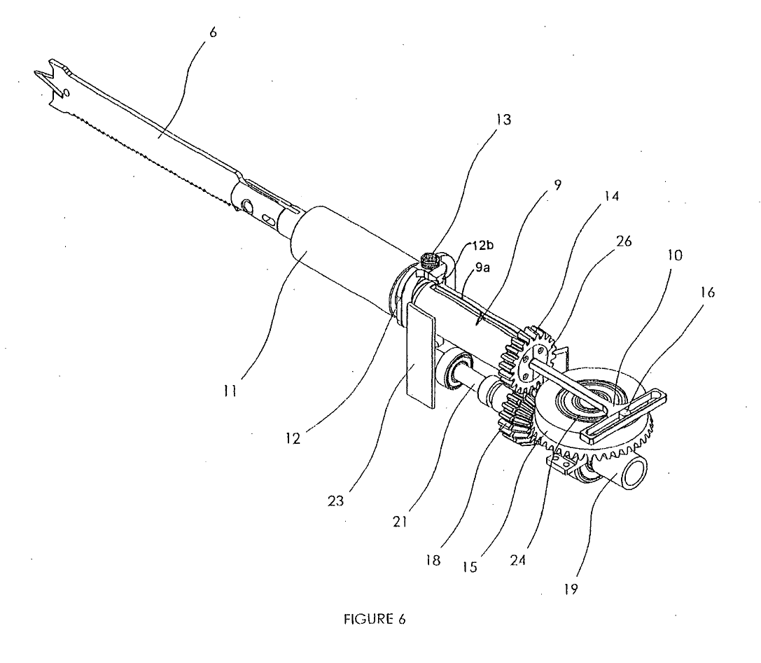

FIG. 6 shows a rear isometric view, which reveals additional detail of some of the components. The shape of the slide pin 12 which rides in channel 9a on the tool holder 9 can be seen. The bearing cover plates 26 hold a bearing in the tool holder 9 to which the Scotch yoke push rod 10 is attached. The bearing allows the yoke to rest idle as the tool holder 9 turns, but maintains a connection to allow it to drive the tool holder 9 back and forth. The insertion point for the motor shaft (not shown) into the motor shaft adaptor 19 is also visible.

Cutting tool blade 6, illustrated in use in FIGS. 3a, 3b, 4a and 4b, is used as both a drill bit and a saw blade. Cutting tool blade 6 comprises a flat, elongate body having angled cutting teeth 6a along its bottom edge. The cutting teeth are angled out that is, slightly from side to side so that the saw kerf is wider than the thickness of the saw blade to inhibit the saw blade from binding against the edges of the cut. One end of the cutting tool blade has a chuck-engaging tang 6b for attaching the tang to tool holder 9 so that, as described above, the combination of tool holder 9 and blade 6 may selectively output both rotary motion E about, and linear motion F along, axis D. The opposite or distal end 6c of cutting tool blade 6 has the shape of a spade drill bit, giving the cutting tool blade the means to function as a drill bit.

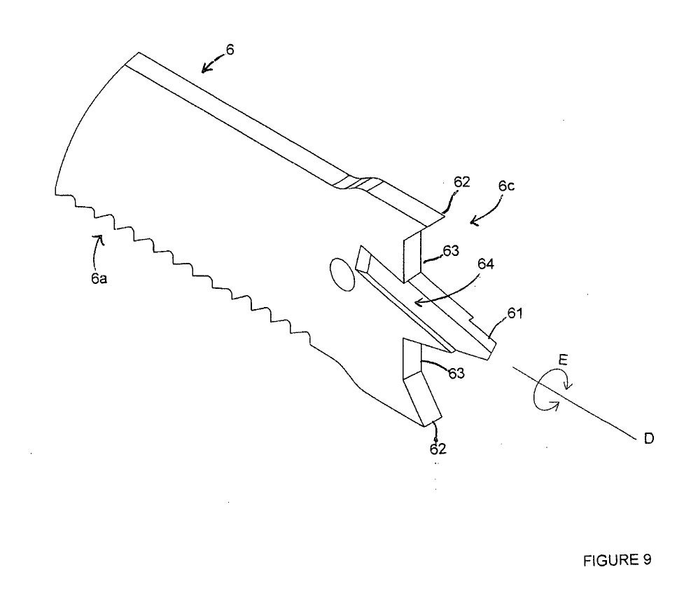

In particular, as better seen in FIG. 9, the tip of cutting tool blade 6 has the contour of a spade bit and thus contains a plurality of angled surfaces to aid in the forming of a pilot hole when driven into a workpiece while the blade is rotating in direction E. A sharp-edged centering point 61 protrudes from the end 6c of cutting tool blade 6 so as to help accurately position the pilot hole by preventing the cutting tool blade 6 from shifting on the surface of the workpiece. Sharp spurs 62 located at the corners of the distal end 6c of the cutting tool blade 6 slice the surface of the workpiece along the outside diameter of the pilot hole to provide a clean cut. The cutting edges 63 scrape along the bottom surface of the pilot hole, removing the material from the workpiece between the centering point 61 and spurs 62.

A chip-clearing slot 64 is provided on each side of the cutting tool blade to remove the debris from the pilot hole during the drilling operation. Loose chips of the material being cut slide along the chip-clearing slot as the cutting tool blade rotates, so as to fall from the pilot hole.

The end of the cutting tool blade that engages tool holder 9 has a chuck-engaging tang 6b with a positioning tab 6d that slides into the chuck 9d of the tool holder 9. A spring-loaded pin assembly or set-screw 9e on tool holder 9 engages the hole 6e located in the chuck-engaging tang 6b to hold the cutting tool firmly in place.

The diameter d1 of the spade drill bit is somewhat larger than the height d2 of the saw blade as seen in FIG. 4b. This allows the pilot hole to have a diameter d1 larger than the height d2 of the saw blade so that the cutting tool blade can easily pass through the workpiece.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A drill saw comprising:
a) a motor,
b) a drive shaft rotationally driven by said motor for rotation of said drive shaft about a corresponding drive axis,
c) a transmission cooperating with said drive shaft to convert said rotation of said drive shaft to a driven output,
d) an output shaft lying on an output axis and cooperating with said transmission for imparting said driven output to said output axis,
wherein said transmission includes:
i) a housing,
ii) a shuttle member having first and second gears mounted thereon, wherein said shuttle member is slidably mounted to said housing for translation between first and second positions,
iii) a rotary motion-to-linearly reciprocating motion converter mounted in said housing and operatively cooperating with said first gear when said shuttle member is in said first position, and wherein when said shuttle member is in said first position said driven output is a first driven output driving said output shaft reciprocatingly and linearly along said output axis,
iv) a rotary motion-to-rotary motion coupler mounted in said housing and operatively cooperating with said second gear when said shuttle member is in said second position, and wherein when said shuttle member is in said second position said driven output is a second driven output driving said output shaft rotationally about said output axis,
e) an actuator for selectively actuating said shuttle member between said first and second positions.

2. The drill saw of claim 1 wherein said output shaft includes a groove extending linearly along an outer surface of said output shaft and parallel to output axis, and wherein said drill saw further comprises a guide member slidably mounted in said housing for sliding translation between an engaged position wherein said guide member engages in said groove as said output shaft is driven by said first driven output, and a disengaged position wherein said guide member is disengaged from said groove as said output shaft is driven by said second driven output.

3. The drill saw of claim 2 wherein said guide member is actuated between said engaged and disengaged positions by an actuating linkage extending between said guide member and said actuator and cooperating with said actuator so as to actuate said guide member into said engaged position when said shuttle member is actuated into said first position and so as to actuate said guide member into said disengaged position when said shuttle member is actuated into said second position.

4. The drill saw of claim 3 wherein said actuating linkage includes a portion of said shuttle member upon said actuation.

5. The drill saw of claim 4 wherein said portion of said shuttle member is a protrusion of said shuttle member, said protrusion driving said guide member upon said actuation.

6. The drill saw of claim 5 wherein said guide member is resiliently biased into said groove by a resilient biasing means, and wherein said guide member further includes a collar through which said output shaft is journalled, and wherein said protrusion drives said collar so as to drive said guide member against the resilient biasing of said resilient biasing means.

7. The drill saw of claim 1 wherein said rotary motion-to-linearly reciprocating motion converter includes a driving wheel having a gear engaging surface which engages with said first gear on said shuttle member when said shuttle member is in said first position, and a driving linkage eccentrically mounted at one end of said linkage to said wheel and mounted at its opposite end to said output shaft whereby rotation of said wheel drives said linkage to thereby linearly translate and reciprocate said output shaft along said output axis.

8. The drill saw of claim 7 wherein said wheel and said linkage are collectively formed as a scotch yoke rotary-to-linear motion converter.

9. The drill saw of claim 7 wherein rotary motion-to-rotary motion coupler includes a rotary output gear mounted on said output shaft cooperating with said second gear when said shuttle member is in said second position.

10. The drill saw of claim 9 wherein said rotary output gear and said second gear are substantially parallel and, when said shuttle member is in said second position, are substantially co-planar.

11. The drill saw of claim 10 wherein said first gear is a first bevel gear and wherein said gear engaging surface on said wheel is a second bevel gear, and wherein said wheel is orthogonal to said first gear.

12. The drill saw of claim 11 wherein said first bevel gear and said second gear form collectively a compound bevel gear wherein said first and second gears are parallel and adjacent.

13. The drill saw of claim 1 further comprising a position sensor mounted in said housing, said position sensor sensing an instantaneous rotary and linear position of said output shaft.

14. The drill saw of claim 13 further comprising a processor cooperating with said position sensor, said processor determining when said groove is aligned with said guide member when said shuttle member is in said first position, said processor determining when said rotary motion-to-rotary motion coupler are operatively connected when said shuttle member is in said second position.

15. The drillsaw of claim 1 further comprising a flat elongate blade having a chuck engaging end, an opposite distal end and a bottom edge extending therebetween along a lower edge of said blade, an array of cutting teeth along said bottom edge, and a spade drill bit at said distal end, wherein said chuck-engaging end is adapted for mounting said blade to said output shaft along said output axis.

16. The drillsaw of claim 14 further comprising a flat elongate blade having a chuck engaging end, an opposite distal end and a bottom edge extending therebetween along a lower edge of said blade, an array of cutting teeth along said bottom edge, and a spade drill bit at said distal end, wherein said chuck-engaging end is adapted for mounting said blade to said output shaft along said output axis.
